(19) United States
(12) Patent Application Publication
(10) Pub. No.: US 2026/0162183 A1
(43) Pub. Date: Jun. 11, 2026

(54) PREDICTING GROSS ESTIMATING COST OF REPAIRS

(71) Applicant: Mitchell International, Inc., San Diego, CA (US)

(72) Inventors: Abhijeet Gulati, San Diego, CA (US); Joseph Hyland, San Diego, CA (US); Mohnish Singh, San Diego, CA (US); Rupesh Kumar, San Diego, CA (US); Alireza Hosseini Jenab, San Diego, CA (US)

(21) Appl. No.: 18/977,038

(22) Filed: Dec. 11, 2024

(51) Int. Cl. G06Q 10/20; G06Q 40/08

(52) U.S. Cl. CPC G06Q 40/08; G06Q 10/20; G06Q 40/09

(57) ABSTRACT

Embodiments of the disclosure provide systems and methods for predicting estimated cost of repairs for a vehicle. According to embodiments of the present disclosure, the estimate review system 305 can provide an Artificial Intelligence (AI)-based solution that can predict an estimated cost of repair. Embodiments can further quantify whether a shop's estimates are competitively written in a specific market/segment, e.g., a particular geographic region. The predicted cost of repair and the shop written estimate can be used to compute a score indicative of the estimate's competitiveness.

### FIELD OF THE DISCLOSURE

Embodiments of the present disclosure relate generally to methods and systems for review of repair cost estimates and more particularly to utilizing artificial intelligence to review repair cost estimates to determine whether the repair cost estimates are competitive within a particular geographic region.

### BACKGROUND

Automotive physical damage claims made to insurance companies begin with an estimate prepared by a shop or other repair facility. The estimate is typically submitted with images and/or video of the damage to the vehicle, descriptive and/or identifying information for the vehicle, line items for repairs to the vehicle, and other information. This can be a large amount of data that needs to be reviewed by the insurance company before approving the estimate or selecting a repair facility based on estimate competitiveness. Given the enormous amount of estimating volume being generated in the claims industry, current review processes can be not only time-consuming and error-prone, but also costly. Hence, there is a need for improved methods and systems for review repair cost estimates.

### BRIEF SUMMARY

Embodiments of the disclosure provide systems and methods for predicting estimated cost of repairs for a vehicle. According to one embodiment, a method for predicting estimated cost of repairs for a vehicle can comprise receiving a claim package for repair of the vehicle. The claim package can comprise vehicle attributes, images and/or videos of damage to the vehicle, a plurality of line items, and a claim estimate by a repair facility for costs of repairs to the vehicle.

An Artificial Intelligence (AI) predicted estimate for costs of repairs to the vehicle can be generated. Generating the AI predicted estimate can comprise training a plurality of predictive models using a plurality of different AI engines and the images and/or videos of damage to the vehicle, wherein the AI predicted estimate is generated using the plurality of predictive models. Training the plurality of predictive models can comprise generating a plurality of initial estimates using the plurality of different AI engines and the images and/or videos of damage to the vehicle, calculating a mean value for the plurality of initial estimates, wherein the plurality of predictive models comprises a first master model trained on at least the calculated mean value for the plurality of initial estimates, and calculating a standard deviation value for the plurality of initial estimates, wherein the plurality of predictive models comprises a second master model trained on the calculated standard deviation value for the plurality of initial estimates.

Generating the AI predicted estimate can further comprise generating a top-down estimate for the costs of repairs to the vehicle using the first master model and the images and/or videos of the damage to the vehicle and generating a top-down standard deviation value for the top-down estimate using the second master model. Generating the AI predicted estimate can further comprise generating a bottom-up estimate for the costs of repairs to the vehicle using a damage assessment model and a plurality of line items generated from a damage assessment model and a rules engine by an intelligent estimating process. The bottom-up estimate for the cost of repairs can be reviewed and bias and claim noise can be eliminated by reviewing the bottom-up estimate cost of repairs against a configurable threshold of cost of repairs. The AI predicted estimate can comprise an average of the top-down estimate and the bottom-up estimate.

A score for the claim estimate can be determined based on the AI predicted estimate, the score indicating a degree of difference between the claim estimate and the AI predicted estimate and thereby providing an assessment of a competitiveness of the claim estimate for a given market of a demographic region, vehicle type, and type of loss. Determining the score for the claim estimate can comprise calculating a predicted estimate mean, the predicted estimate mean comprising the weighted mean of the top-down estimate and the bottom-up estimate, calculating a difference between the predicted estimate mean and the claim estimate, dividing the difference between the predicted estimate mean and the claim estimate by the top-down standard deviation value, and dividing the predicted estimate mean by the claim estimate value.

A confidence value for the score for the claim estimate can be calculated. The confidence value can provide an assessment of uncertainty and is derived from probabilistic outputs which are influenced by the distribution and variability of historical data.

The score for the claim estimate, the confidence value, and degrees of standard deviation between the claim estimate and the AI predicted estimate can be provided to one or more business process workflows. For example, the one or more business process workflows can comprise a claims process for the claim package for repair of the vehicle and the claim package for repair of the vehicle can be routed through the claims process based on the claim estimate, the score for the claim estimate, and the confidence value. Additionally, or alternatively, the claim package for repair of the vehicle can be routed through an automatic approval process based on the claim estimate, the score for the claim estimate, and the confidence value.

According to another embodiment, a system can comprise a processor and a memory coupled with and readable by the processor. The memory can store therein a set of instructions which, when executed by the processor, causes the processor to receive a claim package for repair of the vehicle. The claim package can comprise vehicle attributes, images and/or videos of damage to the vehicle, a plurality of line items, and a claim estimate by a repair facility for costs of repairs to the vehicle.

The instructions can further cause the processor to generate an AI predicted estimate for costs of repairs to the vehicle. Generating the AI predicted estimate can comprise training a plurality of predictive models using a plurality of different AI engines and the images and/or videos of damage to the vehicle, wherein the AI predicted estimate is generated using the plurality of predictive models. Training the plurality of predictive models can comprise generating a plurality of initial estimates using the plurality of different AI engines and the images and/or videos of damage to the vehicle, calculating a mean value for the plurality of initial estimates, wherein the plurality of predictive models comprises a first master model trained on at least the calculated mean value for the plurality of initial estimates, and calculating a standard deviation value for the plurality of initial estimates, wherein the plurality of predictive models comprises a second master model trained on the calculated standard deviation value for the plurality of initial estimates.

Generating the AI predicted estimate can further comprise generating a top-down estimate for the costs of repairs to the vehicle using the first master model and the images and/or videos of the damage to the vehicle and generating a top-down standard deviation value for the top-down estimate using the second master model. Generating the AI predicted estimate can further comprise generating a bottom-up estimate for the costs of repairs to the vehicle using a damage assessment model and a plurality of line items generated from a damage assessment model and a rules engine by an intelligent estimating process. The bottom-up estimate for the cost of repairs can be reviewed and bias and claim noise can be eliminated by reviewing the bottom-up estimate cost of repairs against a configurable threshold of cost of repairs. The AI predicted estimate can comprise an average of the top-down estimate and the bottom-up estimate.

The instructions can further cause the processor to determine a score for the claim estimate based on the AI predicted estimate, the score indicating a degree of difference between the claim estimate and the AI predicted estimate and thereby providing an assessment of a competitiveness of the claim estimate for a given market of a demographic region, vehicle type, and type of loss. Determining the score for the claim estimate can comprise calculating a predicted estimate mean, the predicted estimate mean comprising the weighted mean of the top-down estimate and the bottom-up estimate, calculating a difference between the predicted estimate mean and the claim estimate, dividing the difference between the predicted estimate mean and the claim estimate by the top-down standard deviation value, and dividing the predicted estimate mean by the claim estimate value.

The instructions can further cause the processor to calculate a confidence value for the score for the claim estimate. The confidence value can provide an assessment of uncertainty and is derived from probabilistic outputs which are influenced by the distribution and variability of historical data. The instructions can further cause the processor to provide the score for the claim estimate, the confidence value, and degrees of standard deviation between the claim estimate and the AI predicted estimate to one or more business process workflows. For example, the one or more business process workflows can comprise a claims process for the claim package for repair of the vehicle and the claim package for repair of the vehicle can be routed through the claims process based on the claim estimate, the score for the claim estimate, and the confidence value. Additionally, or alternatively, the claim package for repair of the vehicle can be routed through an automatic approval process based on the claim estimate, the score for the claim estimate, and the confidence value.

According to yet another embodiment, a non-transitory, computer-readable medium can comprise a set of instructions stored therein which, when executed by a processor, can cause the processor to receive a claim package for repair of the vehicle. The claim package can comprise vehicle attributes, images and/or videos of damage to the vehicle, a plurality of line items, and a claim estimate by a repair facility for costs of repairs to the vehicle.

The instructions can further cause the processor to generate an AI predicted estimate for costs of repairs to the vehicle. Generating the AI predicted estimate can comprise training a plurality of predictive models using a plurality of different AI engines and the images and/or videos of damage to the vehicle, wherein the AI predicted estimate is generated using the plurality of predictive models. Training the plurality of predictive models can comprise generating a plurality of initial estimates using the plurality of different AI engines and the images and/or videos of damage to the vehicle, calculating a mean value for the plurality of initial estimates, wherein the plurality of predictive models comprises a first master model trained on at least the calculated mean value for the plurality of initial estimates, and calculating a standard deviation value for the plurality of initial estimates, wherein the plurality of predictive models comprises a second master model trained on the calculated standard deviation value for the plurality of initial estimates.

Generating the AI predicted estimate can further comprise generating a top-down estimate for the costs of repairs to the vehicle using the first master model and the images and/or videos of the damage to the vehicle and generating a top-down standard deviation value for the top-down estimate using the second master model. Generating the AI predicted estimate can further comprise generating a bottom-up estimate for the costs of repairs to the vehicle using a damage assessment model and a plurality of line items generated from a damage assessment model and a rules engine by an intelligent estimating process. The bottom-up estimate for the cost of repairs can be reviewed and bias and claim noise can be eliminated by reviewing the bottom-up estimate cost of repairs against a configurable threshold of cost of repairs. The AI predicted estimate can comprise an average of the top-down estimate and the bottom-up estimate.

The instructions can further cause the processor to determine a score for the claim estimate based on the AI predicted estimate, the score indicating a degree of difference between the claim estimate and the AI predicted estimate and thereby providing an assessment of a competitiveness of the claim estimate for a given market of a demographic region, vehicle type, and type of loss. Determining the score for the claim estimate can comprise calculating a predicted estimate mean, the predicted estimate mean comprising the weighted mean of the top-down estimate and the bottom-up estimate, calculating a difference between the predicted estimate mean and the claim estimate, dividing the difference between the predicted estimate mean and the claim estimate by the top-down standard deviation value, and dividing the predicted estimate mean by the claim estimate value.

The instructions can further cause the processor to calculate a confidence value for the score for the claim estimate. The confidence value provides an assessment of uncertainty and is derived from probabilistic outputs which are influenced by the distribution and variability of historical data. The instructions can further cause the processor to provide the score for the claim estimate, the confidence value, and degrees of standard deviation between the claim estimate and the AI predicted estimate to one or more business process workflows.

### BRIEF DESCRIPTION OF THE DRAWINGS

FIG. 1 is a block diagram illustrating elements of an exemplary computing environment in which embodiments of the present disclosure may be implemented.

FIG. 2 is a block diagram illustrating elements of an exemplary computing device in which embodiments of the present disclosure may be implemented.

FIG. 3 is a block diagram illustrating elements of an exemplary environment for predicting estimated cost of repairs for a vehicle according to one embodiment of the present disclosure.

FIG. 4 is a flowchart illustrating an exemplary process for predicting estimated cost of repairs for a vehicle according to one embodiment of the present disclosure.

FIG. 5 is a flowchart illustrating additional details of an exemplary process for generating an Artificial Intelligence (AI) predicted estimate according to one embodiment of the present disclosure.

FIG. 6 is a flowchart illustrating additional details of an exemplary process for training a plurality of predictive models according to one embodiment of the present disclosure.

FIG. 7 is a flowchart illustrating additional details of an exemplary process for determining a score for a claim estimate according to one embodiment of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a Local-Area Network (LAN) and/or Wide-Area Network (WAN) such as the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM), a Programmable Read-Only Memory (PROM), and Erasable Programable Read-Only Memory (EPROM), a Flash-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, Radio Frequency (RF), etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as Programmable Logic Device (PLD), Programmable Logic Array (PLA), Field Programmable Gate Array (FPGA), Programmable Array Logic (PAL), special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or Very Large-Scale Integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

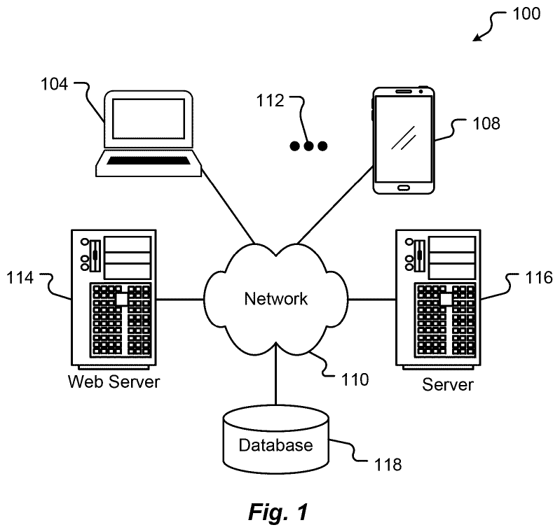

FIG. 1 is a block diagram illustrating elements of an exemplary computing environment in which embodiments of the present disclosure may be implemented. More specifically, this example illustrates a computing environment 100 that may function as the servers, user computers, or other systems provided and described herein. The environment 100 includes one or more user computers, or computing devices, such as a computing device 104, a communication device 108, and/or more 112. The computing devices 104, 108, 112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 104, 108, 112 may also have any of a variety of applications, including for example, database client and/or server applications, and web browser applications. Alternatively, the computing devices 104, 108, 112 may be any other electronic device, such as a thin-client computer, Internet-enabled mobile telephone, and/or personal digital assistant, capable of communicating via a network 110 and/or displaying and navigating web pages or other types of electronic documents. Although the exemplary computer environment 100 is shown with two computing devices, any number of user computers or computing devices may be supported.

Environment 100 further includes a network 110. The network 110 may can be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 110 maybe a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 114, 116. In this example, server 114 is shown as a web server and server 116 is shown as an application server. The web server 114, which may be used to process requests for web pages or other electronic documents from computing devices 104, 108, 112. The web server 114 can be running an operating system including any of those discussed above, as well as any commercially-available server operating systems. The web server 114 can also run a variety of server applications, including SIP servers, HyperText Transfer Protocol (secure) (HTTP(s)) servers, FTP servers, CGI servers, database servers, Java servers, and the like. In some instances, the web server 114 may publish operations available operations as one or more web services.

The environment 100 may also include one or more file and or/application servers 116, which can, in addition to an operating system, include one or more applications accessible by a client running on one or more of the computing devices 104, 108, 112. The server(s) 116 and/or 114 may be one or more general purpose computers capable of executing programs or scripts in response to the computing devices 104, 108, 112. As one example, the server 116, 114 may execute one or more web applications. The web application may be implemented as one or more scripts or programs written in any programming language, such as Java™, C, C#®, or C++, and/or any scripting language, such as Perl, Python, or Tool Command Language (TCL), as well as combinations of any programming/scripting languages. The application server(s) 116 may also include database servers, including without limitation those commercially available from Oracle®, Microsoft®, Sybase®, IBM® and the like, which can process requests from database clients running on a computing device 104, 108, 112.

The web pages created by the server 114 and/or 116 may be forwarded to a computing device 104, 108, 112 via a web (file) server 114, 116. Similarly, the web server 114 may be able to receive web page requests, web services invocations, and/or input data from a computing device 104, 108, 112 (e.g., a user computer, etc.) and can forward the web page requests and/or input data to the web (application) server 116. In further embodiments, the server 116 may function as a file server. Although for ease of description, FIG. 1 illustrates a separate web server 114 and file/application server 116, those skilled in the art will recognize that the functions described with respect to servers 114, 116 may be performed by a single server and/or a plurality of specialized servers, depending on implementation-specific needs and parameters. The computer systems 104, 108, 112, web (file) server 114 and/or web (application) server 116 may function as the system, devices, or components described herein.

The environment 100 may also include a database 118. The database 118 may reside in a variety of locations. By way of example, database 118 may reside on a storage medium local to (and/or resident in) one or more of the computers 104, 108, 112, 114, 116. Alternatively, it may be remote from any or all of the computers 104, 108, 112, 114, 116, and in communication (e.g., via the network 110) with one or more of these. The database 118 may reside in a Storage-Area Network (SAN) familiar to those skilled in the art. Similarly, any necessary files for performing the functions attributed to the computers 104, 108, 112, 114, 116 may be stored locally on the respective computer and/or remotely, as appropriate. The database 118 may be a relational database, such as Oracle 20i®, that is adapted to store, update, and retrieve data in response to Structured Query Language (SQL) formatted commands.

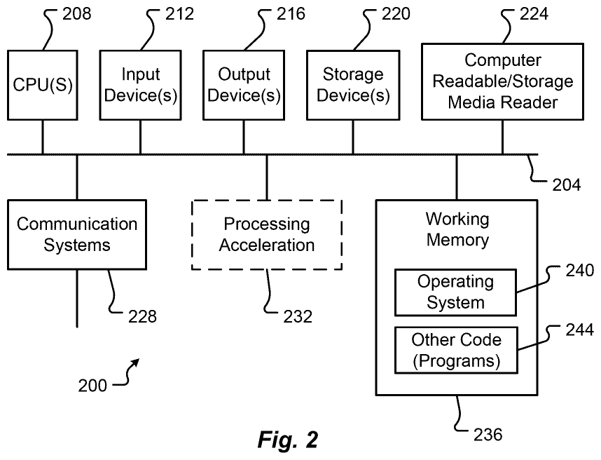

FIG. 2 is a block diagram illustrating elements of an exemplary computing device in which embodiments of the present disclosure may be implemented. More specifically, this example illustrates one embodiment of a computer system 200 upon which the servers, user computers, computing devices, or other systems or components described above may be deployed or executed. The computer system 200 is shown comprising hardware elements that may be electrically coupled via a bus 204. The hardware elements may include one or more Central Processing Units (CPUs) 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a Random-Access Memory (RAM) and/or a Read-Only Memory (ROM), which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a Digital Signal Processor (DSP), a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 200 may also comprise software elements, shown as being currently located within a working memory 236, including an operating system 240 and/or other code 244. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 208 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

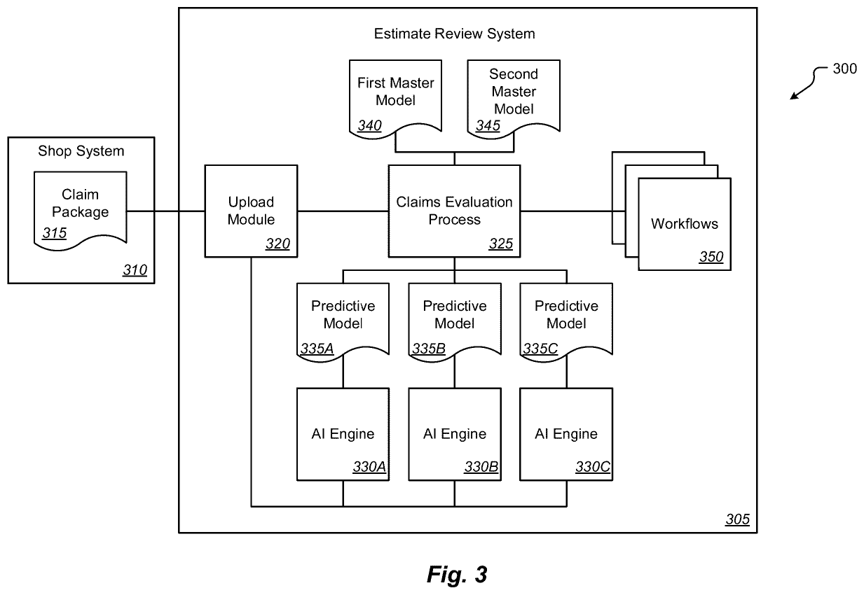

FIG. 3 is a block diagram illustrating elements of an exemplary environment for predicting estimated cost of repairs for a vehicle according to one embodiment of the present disclosure. As illustrated in this example, the environment 300 can comprise an estimate review system 305. The estimate review system 305 can comprise any one or more servers and/or other computing devices as described above. The environment can also include a shop system 310. The shop system 310 can also comprise any one or more servers and/or other computing devices as described above and which may be utilized by an automotive repair shop or other repair facility. The estimate review system 305 and shop system 310 can be communicatively coupled with one another via a communications network (not shown here). The communications network can comprise any one or more wired and/or wireless, local-area and/or wide-area networks as known in the art including, but not limited to, the Internet.

The shop system 310 can generate a claim package related to repair of a damage vehicle. The claim package can include, but is not limited to, information indicating various vehicle attributes, e.g., year, make, model, a Vehicle Identification Number (VIN), etc., images and/or videos of damage to the vehicle, a number of line items each related to a part and/or work to be performed to repair the vehicle, a claim estimate by the shop or repair facility for costs of repairs to the vehicle, and/or other information. The shop system 310 can provide the claim package to the estimate review system 305. For example, an upload module 320 of the estimate review system 305 can provide a set of one or more webpages or other interfaces through which a user of the shop system 310 can provide the claim package information to the estimate review system 305.

According to embodiments of the present disclosure, the estimate review system 305 can provide an Artificial Intelligence (AI)-based solution that can predict an estimated cost of repair. Embodiments can further quantify whether a shop's estimates are competitively written in a specific market/segment, e.g., a particular geographic region. The predicted cost of repair and the shop written estimate can be used to compute a score indicative of the estimate's competitiveness.

It should be noted that embodiments are directed to determining a competitiveness of an estimate which is different than grading or assessing the accuracy of estimates written. Estimate accuracy is a measure of the completeness of an estimate at line level, e.g., Part/Labor operation/Labor Hrs. details, etc. Estimate competitiveness measures whether the estimate written is competitive in the market/segment the shop or repair facility is in as measured by the total cost of repairs. The score for an estimate can be used as a contributing factor in determining estimate candidates for auto-approval. An insurance carrier may utilize a weighted approach to flag specific estimates based on configurable thresholds. The estimate review system 305 can provide this data to an insurance carrier, which can further utilize this data for their reporting and training purposes.

More specifically, the estimate review system 305 can execute a claims evaluation process 325 and any number of AI engines 330A-330C. The AI engines 330A-330C can train a set of predictive models 335A-335C witch together can be used to generate a predicted estimate for a claim. The predictive models 335A-335C can be trained using separate “slices” of production estimates training datasets. Each training-set data “slice” may have a small percentage of overlapping estimates by design. While the data in the training data-set can be mostly unique per each training set, the data distribution can be the same across training datasets.

According to one embodiment, each AI engine 330A-330C, based on the same set of vehicle images, video, and/or other data from the claim package 315, can predict the anticipated cost of repair amount independently. This is analogous to multiple human appraisers assessing the claim virtually and independently. It has been demonstrated, that no two human appraisers write identical estimates for the same claim package 315. The objective of using numerous AI engines 330A-330C is to lower the variability of the predicted cost of repair amount and to improve the certainty of the prediction.

After each AI engine 330A-330C predicts the anticipated cost of repair, the claims evaluation process 325 can compute the mean (μ) cost of predicted repair costs, standard deviation (σ) of the predicted repair costs, and a coefficient of variation CoV=σ/μ. In probability theory and statistics, the coefficient of variation (CoV), also known as Normalized Root-Mean-Square Deviation (NRMSD), Percent RMS, and relative standard deviation (RSD), is a standardized measure of dispersion of a probability distribution or frequency distribution. It shows the extent of variability in relation to the mean of the population. The claims evaluation process 325 can then use the mean and standard deviation to train a first master model 340 (Final Mean Rough Estimate) and second master model 345 (Final Standard Deviation Rough Estimate).

According to one embodiment, the claims evaluation process 325 can then generate an AI predicted estimate by first generating a top-down estimate for the costs of repairs to the vehicle using the first master model 340 and the images and/or videos of the damage to the vehicle and generating a top-down standard deviation value for the top-down estimate using the second master model 345. The top-down estimate can be based on the models learned by regression analysis and is not itemized. A bottom-up estimate for the costs of repairs to the vehicle can be generated using a damage assessment model and a plurality of line items generated from a damage assessment model and a rules engine by an intelligent estimating process. The AI predicted estimate can comprise an average of the top-down estimate and the bottom-up estimate.

The claims evaluation process 325 can then determine a score for the claim estimate based on the AI predicted estimate, the score indicating a degree of difference between the claim estimate and the AI predicted estimate. This score can provide an assessment of a competitiveness of the claim estimate for a given market or region, vehicle type, and type of loss. The claims evaluation process 325 can also calculate a confidence value for the score for the claim estimate. The confidence value can provide an assessment of uncertainty and is derived from probabilistic outputs which are influenced by the distribution and variability of historical data. The claims evaluation process 324 can then provide the score for the claim estimate, the confidence value, and degrees of standard deviation between the claim estimate and the AI predicted estimate to one or more business process workflows 350. These business process workflows 350 can comprise, for example, a claims process, an automatic approval process, etc.

Stated another way, predicting estimated cost of repairs for a vehicle can comprise receiving a claim package 315 for repair of the vehicle from a shop system 310, e.g., through an interface provided by the upload module 320. The claim package 315 can comprise vehicle attributes, images and/or videos of damage to the vehicle, a plurality of line items, and a claim estimate by a repair facility for costs of repairs to the vehicle.

An AI predicted estimate for costs of repairs to the vehicle can be generated by the claims evaluation process 325. Generating the AI predicted estimate can comprise training a plurality of predictive models 335A-335C using a plurality of different AI engines 330A-330C and the images and/or videos of damage to the vehicle. The AI predicted estimate can be generated using the plurality of predictive models 335A-335C. Training the plurality of predictive models 335A-335C can comprise generating a plurality of initial estimates using the plurality of different AI engines 330A-330C and the images and/or videos of damage to the vehicle, calculating a mean value for the plurality of initial estimates, wherein the plurality of predictive models comprises a first master model 340 trained on at least the calculated mean value for the plurality of initial estimates, and calculating a standard deviation value for the plurality of initial estimates, wherein the plurality of predictive models comprises a second master model 345 trained on the calculated standard deviation value for the plurality of initial estimates.

Generating the AI predicted estimate can further comprise generating, by the claims evaluation process 325, a top-down estimate for the costs of repairs to the vehicle using the first master model 340 and the images and/or videos of the damage to the vehicle and generating a top-down standard deviation value for the top-down estimate using the second master model 345. Generating the AI predicted estimate can further comprise generating, by the claims evaluation process 325, a bottom-up estimate for the costs of repairs to the vehicle using a damage assessment model and a plurality of line items generated from a damage assessment model and a rules engine by an intelligent estimating process. The bottom-up estimate for the cost of repairs can be reviewed and bias and claim noise can be eliminated by reviewing the bottom-up estimate cost of repairs against a configurable threshold of cost of repairs. The AI predicted estimate can comprise an average of the top-down estimate and the bottom-up estimate.

The claims evaluation process 325 can the determine a score for the claim estimate based on the AI predicted estimate. The score can indicate a degree of difference between the claim estimate and the AI predicted estimate and thereby provide an assessment of a competitiveness of the claim estimate for a given market of a demographic region, vehicle type, and type of loss. Determining the score for the claim estimate can comprise calculating, by the claims evaluation process 325, a predicted estimate mean. The predicted estimate mean can comprise the weighted mean of the top-down estimate and the bottom-up estimate. Determining the score for the claim estimate can comprise calculating, by the claims evaluation process 325, calculating a difference between the predicted estimate mean and the claim estimate, dividing the difference between the predicted estimate mean and the claim estimate by the top-down standard deviation value, and dividing the predicted estimate mean by the claim estimate value.

A confidence value for the score for the claim estimate can be calculated by the claims evaluation process 325. The confidence value can provide an assessment of uncertainty and is derived from probabilistic outputs which are influenced by the distribution and variability of historical data.

The score for the claim estimate, the confidence value, and degrees of standard deviation between the claim estimate and the AI predicted estimate can be provided by the claims evaluation process 325 to one or more business process workflows. For example, the one or more business process workflows can comprise a claims process for the claim package for repair of the vehicle and the claim package for repair of the vehicle can be routed through the claims process based on the claim estimate, the score for the claim estimate, and the confidence value. Additionally, or alternatively, the claim package for repair of the vehicle can be routed through an automatic approval process based on the claim estimate, the score for the claim estimate, and the confidence value.

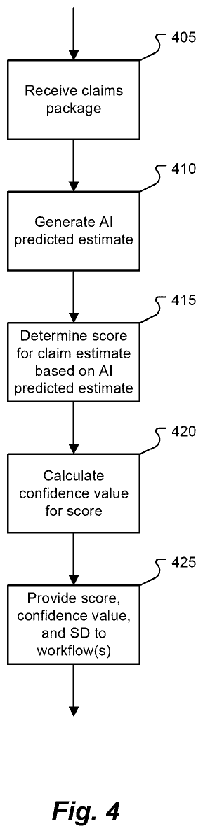

FIG. 4 is a flowchart illustrating an exemplary process for predicting estimated cost of repairs for a vehicle according to one embodiment of the present disclosure. As illustrated in this example, predicting estimated cost of repairs for a vehicle can comprise receiving 405 a claim package for repair of the vehicle. The claim package can include, but us not limited to, vehicle attributes, images and/or videos of damage to the vehicle, a plurality of line items, a claim estimate by a repair facility for costs of repairs to the vehicle, and/or other information.

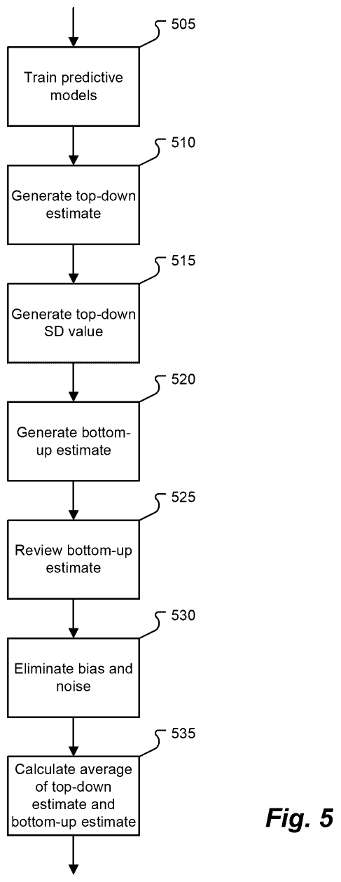

An AI predicted estimate for costs of repairs to the vehicle can be generated 410. Generally speaking, various AI processes can be applied to vehicle attributes, images and/or videos of the damage to the vehicle, the line items, the claim estimate, and/or other information in the received claim package. These AI processes can generate a prediction of an estimate for repairs to the vehicle. Additional details of an exemplary process for generating 410 an AI predicted estimate for costs of repairs will be described below with reference to FIG. 5.

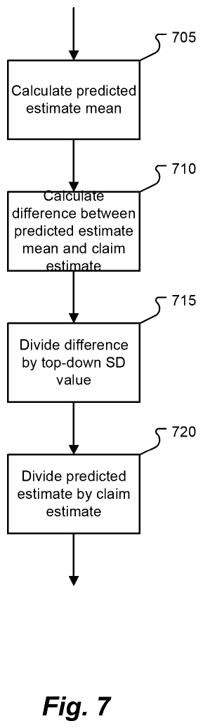

A score for the claim estimate can be determined 415 based on the AI predicted estimate. The score can indicate a degree of difference between the claim estimate and the AI predicted estimate. As such, the score can providing an assessment of a competitiveness of the claim estimate for a given market of or within a particular demographic region and for the vehicle type and type of loss. Additional details of an exemplary process for determining 415 a score for a claim estimate will be described below with reference to FIG. 7.

A confidence value for the score for the claim estimate can be calculated 420. The confidence value can provide an assessment of uncertainty and can be derived from probabilistic outputs which are influenced by the distribution and variability of historical data. The score for the claim estimate, the confidence value, and degrees of standard deviation between the claim estimate and the AI predicted estimate can then be provided 425 to one or more business process workflows. For example, the one or more business process workflows can comprise a claims process for the claim package for repair of the vehicle. In such cases, the claim package for repair of the vehicle can be routed through the claims process based on the claim estimate, the score for the claim estimate, and the confidence value. Additionally, or alternatively, the claim package for repair of the vehicle can be routed through an automatic approval process based on the claim estimate, the score for the claim estimate, and the confidence value.

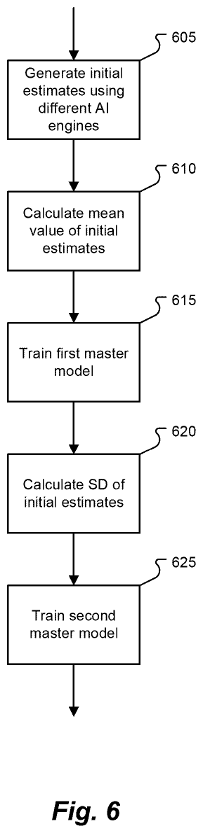

FIG. 5 is a flowchart illustrating additional details of an exemplary process for generating an Artificial Intelligence (AI) predicted estimate according to one embodiment of the present disclosure. As illustrated in this example, generating the AI predicted estimate can comprise training 505 a plurality of predictive models using a plurality of different AI engines and the images and/or videos of damage to the vehicle. The AI predicted estimate can be generated using the plurality of predictive models. Additional details of an exemplary process for training 505 different AI models will be described below with reference to FIG. 6.

Generating the AI predicted estimate can further comprise generating 510 a top-down estimate for the costs of repairs to the vehicle using the first master model and the images and/or videos of the damage to the vehicle and generating 515 a top-down standard deviation value for the top-down estimate using the second master model. A bottom-up estimate for the costs of repairs to the vehicle can also be generated 520 using a damage assessment model and a plurality of line items generated from a damage assessment model and a rules engine by an intelligent estimating process. The bottom-up estimate for the cost of repairs can be reviewed 525 and bias and claim noise can be eliminated 530 by reviewing the bottom-up estimate cost of repairs against a configurable threshold of cost of repairs. The AI predicted estimate can then be calculated 535 by calculating an average of the top-down estimate and the bottom-up estimate.

FIG. 6 is a flowchart illustrating additional details of an exemplary process for training a plurality of predictive models according to one embodiment of the present disclosure. As illustrated in this example, training the plurality of predictive models can comprise generating 605 a plurality of initial estimates using the plurality of different AI engines and the images and/or videos of damage to the vehicle. A mean value for the plurality of initial estimates can then be calculated 610. The plurality of predictive models can comprises a first master model trained 615 on at least the calculated mean value for the plurality of initial estimates. Additionally, or alternatively, the first master model can be trained 615 using one or more other statistical methods including a simple average of the initial estimates, a weighted average of the initial estimates, a median of the initial estimates, and/or other methods. A standard deviation value for the plurality of initial estimates can be calculated 620. The plurality of predictive models can comprise a second master model trained 625 on the calculated standard deviation value for the plurality of initial estimates.

FIG. 7 is a flowchart illustrating additional details of an exemplary process for determining a score for a claim estimate according to one embodiment of the present disclosure. As illustrated in this example, determining the score for the claim estimate can comprise calculating 705 a predicted estimate mean. The predicted estimate mean can comprise the weighted mean of the top-down estimate and the bottom-up estimate. A difference between the predicted estimate mean and the claim estimate can be calculated 710. The difference between the predicted estimate mean and the claim estimate can be divided 715 by the top-down standard deviation value and the predicted estimate mean can be divided 720 by the claim estimate value.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for predicting estimated cost of repairs for a vehicle, the method comprising:
receiving, by a processor of an estimate review system, a claim package for repair of the vehicle, the claim package comprising vehicle attributes, images and/or videos of damage to the vehicle, a plurality of line items, and a claim estimate by a repair facility for costs of repairs to the vehicle;
generating, by the processor of the estimate review system, an Artificial Intelligence (AI) predicted estimate for costs of repairs to the vehicle;
determining, by the processor of the estimate review system, a score for the claim estimate based on the AI predicted estimate, the score indicating a degree of difference between the claim estimate and the AI predicted estimate and thereby providing an assessment of a competitiveness of the claim estimate for a given market of a demographic region, vehicle type, and type of loss;
calculating, by the processor of the estimate review system, a confidence value for the score for the claim estimate, wherein the confidence value provides an assessment of uncertainty and is derived from probabilistic outputs which are influenced by the distribution and variability of historical data; and
providing, by the processor of the estimate review system, the score for the claim estimate, the confidence value, and degrees of standard deviation between the claim estimate and the AI predicted estimate to one or more business process workflows.

2. The method of claim 1, wherein generating the AI predicted estimate comprises training a plurality of predictive models using a plurality of different AI engines and the images and/or videos of damage to the vehicle, wherein the AI predicted estimate is generated using the plurality of predictive models.

3. The method of claim 2, wherein training the plurality of predictive models comprises:
generating a plurality of initial estimates using the plurality of different AI engines and the images and/or videos of damage to the vehicle;
calculating a mean value for the plurality of initial estimates, wherein the plurality of predictive models comprises a first master model trained on at least the calculated mean value for the plurality of initial estimates; and
calculating a standard deviation value for the plurality of initial estimates, wherein the plurality of predictive models comprises a second master model trained on the calculated standard deviation value for the plurality of initial estimates.

4. The method of claim 3, wherein generating the AI predicted estimate further comprises:
generating a top-down estimate for the costs of repairs to the vehicle using the first master model and the images and/or videos of the damage to the vehicle; and
generating a top-down standard deviation value for the top-down estimate using the second master model.

5. The method of claim 4, wherein generating the AI predicted estimate further comprises generating a bottom-up estimate for the costs of repairs to the vehicle using a damage assessment model and a plurality of line items generated from a damage assessment model and a rules engine by an intelligent estimating process.

6. The method of claim 5, further comprising:
reviewing the bottom-up estimate for the cost of repairs; and
eliminating bias and claim noise by reviewing the bottom-up estimate cost of repairs against a configurable threshold of cost of repairs.

7. The method of claim 5, wherein the AI predicted estimate comprises an average of the top-down estimate and the bottom-up estimate.

8. The method of claim 7, wherein determining the score for the claim estimate comprises:
calculating a predicted estimate mean, the predicted estimate mean comprising the weighted mean of the top-down estimate and the bottom-up estimate;
calculating a difference between the predicted estimate mean and the claim estimate;
dividing the difference between the predicted estimate mean and the claim estimate by the top-down standard deviation value; and
dividing the predicted estimate mean by the claim estimate value.

9. The method of claim 1, wherein the one or more business process workflows comprise a claims process for the claim package for repair of the vehicle and wherein the claim package for repair of the vehicle is routed through the claims process based on the claim estimate, the score for the claim estimate, and the confidence value.

10. The method of claim 9, wherein the claim package for repair of the vehicle is routed through an automatic approval process based on the claim estimate, the score for the claim estimate, and the confidence value.

11. A system comprising:
a processor; and
a memory coupled with and readable by the processor and storing therein a set of instructions which, when executed by the processor, causes the processor to:
receive a claim package for repair of the vehicle, the claim package comprising vehicle attributes, images and/or videos of damage to the vehicle, a plurality of line items, and a claim estimate by a repair facility for costs of repairs to the vehicle;
generate an Artificial Intelligence (AI) predicted estimate for costs of repairs to the vehicle;
determine a score for the claim estimate based on the AI predicted estimate, the score indicating a degree of difference between the claim estimate and the AI predicted estimate and thereby providing an assessment of a competitiveness of the claim estimate for a given market of a demographic region, vehicle type, and type of loss;
calculate a confidence value for the score for the claim estimate, wherein the confidence value provides an assessment of uncertainty and is derived from probabilistic outputs which are influenced by the distribution and variability of historical data; and
provide the score for the claim estimate, the confidence value, and degrees of standard deviation between the claim estimate and the AI predicted estimate to one or more business process workflows.

12. The system of claim 11, wherein generating the AI predicted estimate comprises training a plurality of predictive models using a plurality of different AI engines and the images and/or videos of damage to the vehicle, wherein the AI predicted estimate is generated using the plurality of predictive models.

13. The system of claim 12, wherein training the plurality of predictive models comprises:
generating a plurality of initial estimates using the plurality of different AI engines and the images and/or videos of damage to the vehicle;
calculating a mean value for the plurality of initial estimates, wherein the plurality of predictive models comprises a first master model trained on at least the calculated mean value for the plurality of initial estimates; and
calculating a standard deviation value for the plurality of initial estimates, wherein the plurality of predictive models comprises a second master model trained on the calculated standard deviation value for the plurality of initial estimates.

14. The system of claim 13, wherein generating the AI predicted estimate further comprises:
generating a top-down estimate for the costs of repairs to the vehicle using the first master model and the images and/or videos of the damage to the vehicle; and
generating a top-down standard deviation value for the top-down estimate using the second master model.

15. The system of claim 14, wherein generating the AI predicted estimate further comprises generating a bottom-up estimate for the costs of repairs to the vehicle using a damage assessment model and a plurality of line items generated from a damage assessment model and a rules engine by an intelligent estimating process.

16. The system of claim 15, wherein the instructions further cause the processor to:
review the bottom-up estimate for the cost of repairs; and
eliminate bias and claim noise by reviewing the bottom-up estimate cost of repairs against a configurable threshold of cost of repairs.

17. The system of claim 15, wherein the AI predicted estimate comprises an average of the top-down estimate and the bottom-up estimate.

18. The system of claim 17, wherein determining the score for the claim estimate comprises:
calculating a predicted estimate mean, the predicted estimate mean comprising the weighted mean of the top-down estimate and the bottom-up estimate;
calculating a difference between the predicted estimate mean and the claim estimate;
dividing the difference between the predicted estimate mean and the claim estimate by the top-down standard deviation value; and
dividing the predicted estimate mean by the claim estimate value.

19. The system of claim 11, wherein the one or more business process workflows comprise a claims process for the claim package for repair of the vehicle and wherein the claim package for repair of the vehicle is routed through the claims process based on the claim estimate, the score for the claim estimate, and the confidence value.

20. The system of claim 19, wherein the claim package for repair of the vehicle is routed through an automatic approval process based on the claim estimate, the score for the claim estimate, and the confidence value.

21. A non-transitory, computer-readable medium comprising a set of instructions stored therein which, when executed by a processor, causes the processor to:
receive a claim package for repair of the vehicle, the claim package comprising vehicle attributes, images and/or videos of damage to the vehicle, a plurality of line items, and a claim estimate by a repair facility for costs of repairs to the vehicle;
generate an Artificial Intelligence (AI) predicted estimate for costs of repairs to the vehicle;
determine a score for the claim estimate based on the AI predicted estimate, the score indicating a degree of difference between the claim estimate and the AI predicted estimate and thereby providing an assessment of a competitiveness of the claim estimate for a given market of a demographic region, vehicle type, and type of loss;
calculate a confidence value for the score for the claim estimate, wherein the confidence value provides an assessment of uncertainty and is derived from probabilistic outputs which are influenced by the distribution and variability of historical data; and
provide the score for the claim estimate, the confidence value, and degrees of standard deviation between the claim estimate and the AI predicted estimate to one or more business process workflows.

22. The non-transitory, computer-readable medium of claim 21, wherein generating the AI predicted estimate comprises training a plurality of predictive models using a plurality of different AI engines and the images and/or videos of damage to the vehicle, wherein the AI predicted estimate is generated using the plurality of predictive models.

23. The non-transitory, computer-readable medium of claim 22, wherein training the plurality of predictive models comprises:
generating a plurality of initial estimates using the plurality of different AI engines and the images and/or videos of damage to the vehicle;
calculating a mean value for the plurality of initial estimates, wherein the plurality of predictive models comprises a first master model trained on at least the calculated mean value for the plurality of initial estimates; and
calculating a standard deviation value for the plurality of initial estimates, wherein the plurality of predictive models comprises a second master model trained on the calculated standard deviation value for the plurality of initial estimates.

24. The non-transitory, computer-readable medium of claim 23, wherein generating the AI predicted estimate further comprises:
generating a top-down estimate for the costs of repairs to the vehicle using the first master model and the images and/or videos of the damage to the vehicle; and
generating a top-down standard deviation value for the top-down estimate using the second master model; and
generating a bottom-up estimate for the costs of repairs to the vehicle using a damage assessment model and the plurality of line items.

25. The non-transitory, computer-readable medium of claim 24, wherein the AI predicted estimate comprises an average of the top-down estimate and the bottom-up estimate.

26. The non-transitory, computer-readable medium of claim 25, wherein determining the score for the claim estimate comprises:
calculating a predicted estimate mean, the predicted estimate mean comprising the weighted mean of the top-down estimate and the bottom-up estimate;
calculating a difference between the predicted estimate mean and the claim estimate;
dividing the difference between the predicted estimate mean and the claim estimate by the top-down standard deviation value; and
dividing the predicted estimate mean by the claim estimate value.
